(19) United States
(12) Patent Application Publication
(10) Pub. No.: US 2020/0117049 A1
(43) Pub. Date: Apr. 16, 2020

(54) LIQUID CRYSTAL DISPLAY APPARATUS

(71) Applicant: Panasonic Intellectual Property Management Co., Ltd., Osaka (JP)

(72) Inventor: KOJI MIMURA, Kanagawa (JP)

(21) Appl. No.: 16/712,870

(22) Filed: Dec. 12, 2019

Related U.S. Application Data
(63) Continuation of application No. PCT/JP2018/024283, filed on Jun. 27, 2018.

(30) Foreign Application Priority Data
Jun. 29, 2017 (JP) 2017-127032

(51) Int. Cl. G02F 1/1335; G02F 1/13363; G02F 1/1333

(52) U.S. Cl. CPC G02F 1/133528; G02F 1/13363; G02F 2001/133317; G02F 2001/133638; G02F 2001/133567; G02F 1/133308

(57) ABSTRACT

A liquid crystal display apparatus includes a liquid crystal display panel, a light source, an optical sheet, a frame, and an optical element. The light source is opposed to the liquid crystal display panel. The optical sheet is disposed between the liquid crystal display panel and the light source, and includes a first functional layer transmitting a polarized component in one direction of light emitted from the light source and a second functional layer that controls an outgoing direction of the light transmitted through the first functional layer. The frame is disposed around the liquid crystal display panel, and includes a protrusion protruding toward an inner peripheral side between the liquid crystal display panel and the optical sheet and supporting the liquid crystal display panel. The optical element is disposed on an optical path of light outgoing from the optical sheet toward the protrusion of the frame, and changes a polarized state of light.

### TECHNICAL FIELD

The present disclosure relates to a liquid crystal display apparatus having a viewing angle limiting function.

### BACKGROUND ART

An on-vehicle liquid crystal display apparatus including a louver that limits a vertical viewing angle is known in order to prevent an image from being reflected into a windshield of a vehicle (for example, see PTL 1).

### CITATION LIST

### Patent Literature

PTL 1: Unexamined Japanese Patent Publication No. 2005-275262

### SUMMARY OF THE INVENTION

The present disclosure provides a liquid crystal display apparatus that can prevent light leakage.

According to one aspect of the present disclosure, a liquid crystal display apparatus includes a liquid crystal display panel, a light source, an optical sheet, a frame, and an optical element. The light source is opposed to the liquid crystal display panel. The optical sheet is disposed between the liquid crystal display panel and the light source, and includes a first functional layer transmitting a polarized component in one direction of light emitted from the light source and a second functional layer that controls an outgoing direction of the light transmitted through the first functional layer. The frame is disposed around the liquid crystal display panel, and includes a protrusion protruding toward an inner peripheral side between the liquid crystal display panel and the optical sheet and supporting the liquid crystal display panel. The optical element is disposed on an optical path of light outgoing from the optical sheet toward the protrusion of the frame, and changes a polarized state of light.

According to another aspect of the present disclosure, a liquid crystal display apparatus includes a liquid crystal display panel, a light source, an optical sheet, and a frame. The light source is opposed to the liquid crystal display panel. The optical sheet is disposed between the liquid crystal display panel and the light source, and controls an outgoing direction of light emitted from the light source. The frame is disposed around the liquid crystal display panel, and includes a protrusion protruding toward an inner peripheral side between the liquid crystal display panel and the optical sheet and supporting the liquid crystal display panel. An inner end face on an inner peripheral side of the protrusion is inclined with respect to a normal of the optical sheet.

According to the present disclosure, the light leakage can be prevented in the liquid crystal display apparatus.

### BRIEF DESCRIPTION OF DRAWINGS

FIG. 1 is a plan view illustrating a liquid crystal display apparatus according to a first exemplary embodiment.

FIG. 2 is a sectional view of the liquid crystal display apparatus taken along a line II-II in FIG. 1.

FIG. 3 is a sectional view illustrating a liquid crystal display apparatus of a comparative example.

FIG. 4 is a sectional view illustrating a liquid crystal display apparatus according to a second exemplary embodiment.

FIG. 5 is a sectional view illustrating a liquid crystal display apparatus according to a third exemplary embodiment.

FIG. 6A is a sectional view illustrating another structure of a protrusion in the liquid crystal display apparatus of the third exemplary embodiment.

FIG. 6B is a sectional view illustrating still another structure of the protrusion in the liquid crystal display apparatus of the third exemplary embodiment.

FIG. 6C is a sectional view illustrating yet another structure of the protrusion in the liquid crystal display apparatus of the third exemplary embodiment.

FIG. 7 is a sectional view illustrating a liquid crystal display apparatus according to a fourth exemplary embodiment.

FIG. 8 is a sectional view illustrating a liquid crystal display apparatus according to a fifth exemplary embodiment.

### DESCRIPTION OF EMBODIMENT

Prior to description of an exemplary embodiment of the present disclosure, problems of conventional techniques will briefly be described. In the liquid crystal display apparatus in which the vertical viewing angle is limited, sometimes light toward a direction largely inclined onto an upper side with respect to a normal of a screen leaks linearly from a vicinity of a lower edge of the screen due to a structure of a frame supporting the liquid crystal display panel. There is a possibility of reflecting the light leakage into the windshield of the vehicle.

### First Exemplary Embodiment

An outline will be described prior to specific description of a first exemplary embodiment. The first exemplary embodiment relates to a liquid crystal display apparatus having a viewing angle limiting function. For example, the liquid crystal display apparatus can be supposed to be mounted on a vehicle. The liquid crystal display apparatus includes a liquid crystal display panel, a backlight, an optical sheet disposed between the liquid crystal display panel and the backlight, and a middle frame disposed around the liquid crystal display panel. The optical sheet has a polarizing function of transmitting a polarized component in one direction of light emitted from the backlight and the viewing angle limiting function of controlling an outgoing direction of the light of the polarized component in one direction. The middle frame includes a protrusion protruding toward an inner peripheral side between the liquid crystal display panel and the optical sheet, and supports the liquid crystal display panel. In the liquid crystal display apparatus of the first exemplary embodiment, a quarter wave plate is disposed on an optical path of light outgoing from the optical sheet toward an inner end face of the protrusion of the frame.

In the description, the terms “sheet”, “film”, and “plate” should not be distinguished from one another based only on a difference of a name. For example, “sheet” is a concept including a member that can be called a film or a plate, and therefore “optical sheet” cannot be distinguished from a member called “optical film” or “optical plate” only in the difference of the name.

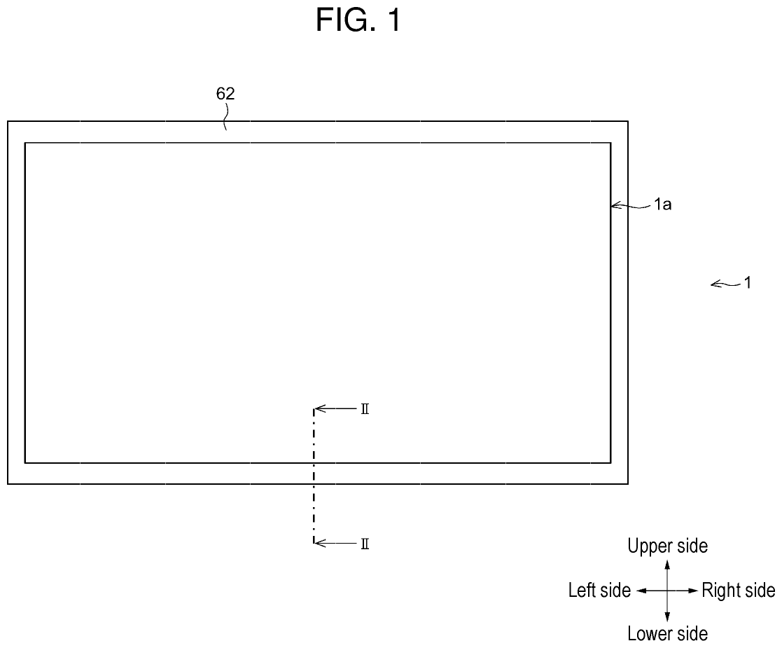

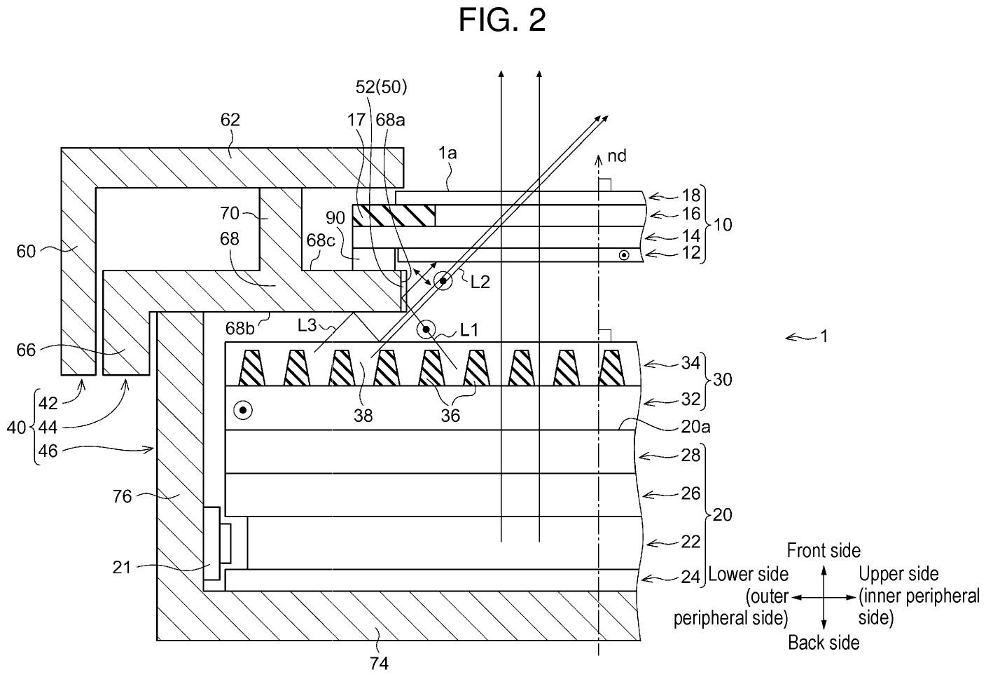

FIG. 1 is a plan view illustrating liquid crystal display apparatus 1 according to a first exemplary embodiment. FIG. 2 is a sectional view of liquid crystal display apparatus 1 taken along a line II-II in FIG. 1. FIG. 2 illustrates a section in a lower edge region of liquid crystal display apparatus 1. As illustrated in FIG. 1, liquid crystal display apparatus 1 has a rectangular shape in planar view, and includes display surface 1a. An edge of display surface 1a is surrounded by bezel 62. As illustrated in FIG. 2, liquid crystal display apparatus 1 includes liquid crystal display panel 10, backlight 20, optical sheet 30, support frame 40, and optical element 50.

In the following description, in a thickness direction of liquid crystal display panel 10, a side on which liquid crystal display panel 10 is disposed with respect to backlight 20 is referred to as a front surface side, and a side opposite thereto is referred to a back surface side. In an in-plane direction of liquid crystal display panel 10, a side on which liquid crystal display panel 10 is disposed with respect to middle frame 44 is referred to as an inner peripheral side, and a side opposite thereto is referred to an outer peripheral side.

Liquid crystal display panel 10 controls transmission or interruption of light from backlight 20 in each pixel, and displays an image on display surface 1a. Liquid crystal display panel 10 includes lower polarizing plate 12, thin film transistor substrate 14, color filter substrate 16, and upper polarizing plate 18.

Lower polarizing plate 12 is disposed on the back surface side of liquid crystal display panel 10. Thin film transistor substrate 14 is disposed on the front surface side of lower polarizing plate 12. Color filter substrate 16 is disposed on the front surface side of thin film transistor substrate 14. Color filter substrate 16 includes black matrix 17 having a light shielding function in a margin in planar view. Upper polarizing plate 18 is disposed on the front surface side of color filter substrate 16. A liquid crystal layer (not illustrated) is disposed between thin film transistor substrate 14 and color filter substrate 16.

Each of lower polarizing plate 12 and upper polarizing plate 18 has a function of resolving incident light into two polarized components (a P wave and an S wave) orthogonal to each other, transmitting a linearly polarized component (for example, the P wave) vibrating in one direction, and absorbing a linearly polarized component (for example, the S wave) vibrating the other direction orthogonal to one direction. One direction is one parallel to a transmission axis, and hereinafter referred to as a first direction. The other direction is one parallel to an absorption axis, and hereinafter referred to as a second direction. In the examples of FIGS. 1 and 2, the transmission axis of lower polarizing plate 12 is substantially parallel to a horizontal direction, and the absorption axis of lower polarizing plate 12 is substantially parallel to a vertical direction.

Liquid crystal display panel 10 is based on a known technique, and the further detail description is omitted.

Backlight 20 is opposed to liquid crystal display panel 10 with optical sheet 30 interposed therebetween. Backlight 20 includes light emitting surface 20a that emits light in a planar manner, and acts as a light source that illuminates liquid crystal display panel 10 in the planar manner from the back surface side through optical sheet 30. Backlight 20 includes light emitting source 21, light guide plate 22, reflector 24, diffuser 26, and prism sheet 28.

Light emitting source 21 is disposed opposite to a side face of light guide plate 22, and emits light to the side face of light guide plate 22. In light guide plate 22, the light incident from the side face exists substantially uniformly from a front surface, whereby backlight 20 acts as a plane light source. Reflector 24 is disposed on the back surface side of light guide plate 22, reflects the light leaking from a rear surface of light guide plate 22, and returns the light into light guide plate 22. Diffuser 26 is disposed on the front surface side of light guide plate 22, and diffuses the light outgoing from light guide plate 22. Prism sheet 28 is disposed on the front surface side of diffuser 26, bends a traveling direction of the light diffused by diffuser 26 such that the light comes close to normal ‘nd’ of optical sheet 30, and causes the light to exit from light emitting surface 20a.

Backlight 20 is based on a known technique, and the further detail description is omitted.

Optical sheet 30 is disposed between liquid crystal display panel 10 and backlight 20, and joined to light emitting surface 20a of backlight 20 in the illustrated examples. A space is provided between optical sheet 30 and liquid crystal display panel 10. Optical sheet 30 includes first functional layer 32 and second functional layer 34 disposed on the front surface side of first functional layer 32.

First functional layer 32 is also referred to as a reflection type polarizing film, transmits the linearly polarized component in the first direction of the light outgoing from backlight 20, and reflects the linearly polarized component in the second direction. The direction of the transmission axis of first functional layer 32 is substantially parallel to the direction of the transmission axis of lower polarizing plate 12. For this reason, the light transmitted through first functional layer 32 is also transmitted through lower polarizing plate 12 unless the polarized direction is changed until the light reaches lower polarizing plate 12.

The light reflected from first functional layer 32 is returned to backlight 20, and reflected from a surface of each layer constituting backlight 20 again. The polarized direction of the light reflected from the surface of each layer again is changed during the reflection, and returned to first functional layer 32 again. Part of the light returned to first functional layer 32 is transmitted through first functional layer 32, another part of the light is reflected again.

Second functional layer 34 is also referred to as a light control film, and controls an outgoing direction of the light transmitted through first functional layer 32. Second functional layer 34 has a function of selectively absorbing the light largely inclined with respect to normal ‘nd’ of optical sheet 30. Consequently, liquid crystal display apparatus 1 exerts a viewing angle limiting function.

Second functional layer 34 includes a plurality of light shielding units 36 absorbing the light and light transmission layer 38 transmitting the light. The plurality of light shielding units 36 are vertically arranged at predetermined intervals. Although not illustrated, the plurality of light shielding units 36 extend in the horizontal direction. Light transmission layer 38 is disposed so as to cover a gap between the plurality of light shielding units 36 and the front surface side of the plurality of light shielding units 36. In the light transmitted through first functional layer 32, most of the light toward light shielding unit 36 is absorbed by light shielding unit 36, and the light traveling in light transmission layer 38 is transmitted through light transmission layer 38, and directed to liquid crystal display panel 10.

Optical sheet 30 is based on a known technique, and the further detail description is omitted.

Support frame 40 includes front frame 42, middle frame 44, and rear frame 46. Front frame 42 is disposed around liquid crystal display panel 10. An outer shape of front frame 42 has a rectangular shape in planar view. Front frame 42 includes sidewall 60 and bezel 62. Sidewall 60 is disposed on outer peripheral sides of middle frame 44 and rear frame 46. Bezel 62 extends from an end on the front surface side of sidewall 60, and is opposed to an edge region of liquid crystal display panel 10.

Middle frame 44 is disposed around liquid crystal display panel 10. An outer shape of middle frame 44 has a rectangular shape in planar view. Metal or a synthetic resin is used for a material of middle frame 44. Preferably middle frame 44 has a black or deep color and a light shielding property.

Middle frame 44 includes sidewall 66, protrusion 68, and sidewall 70.

Sidewall 66 is disposed between sidewall 60 of front frame 42 and rear frame 46. Protrusion 68 protrudes from the end on the front surface side of sidewall 66 toward an inner peripheral side between liquid crystal display panel 10 and optical sheet 30, and supports liquid crystal display panel 10. Inner end face 68a on the inner peripheral side of protrusion 68 is substantially parallel to normal ‘nd’ of optical sheet 30. Front surface 68c of protrusion 68 is joined to the edge region of thin film transistor substrate 14 of liquid crystal display panel 10 while cushion tape 90 absorbing impact is interposed therebetween. On the inner peripheral side from sidewall 66, sidewall 70 extends from front surface 68c of protrusion 68 toward the front surface side. The end on the front surface side of sidewall 70 abuts on the back surface of bezel 62 of front frame 42, and supports front frame 42.

Rear frame 46 has a substantial box shape including an opening on the front surface side, and accommodates backlight 20 and optical sheet 30. An outer shape of rear frame 46 has a rectangular shape in planar view. Rear frame 46 includes back surface unit 74 and sidewall 76. Back surface unit 74 support backlight 20 from the back surface side. Sidewall 76 extends from an edge of back surface unit 74 toward the front surface side. Light emitting source 21 is fixed to the side face on the inner peripheral side of sidewall 76. The end on the front surface side of sidewall 76 abuts on back surface 68b of protrusion 68 of middle frame 44, and supports middle frame 44.

Although not illustrated, support frame 40 has the substantially same sectional shape as that in FIG. 2 on an upper side, a right side, and a left side of display surface 1a.

Optical element 50 is disposed on an optical path of the light outgoing from optical sheet 30 toward protrusion 68 of middle frame 44, and changes a polarized state of the light. Specifically, optical element 50 includes quarter wave plate 52 disposed on inner end face 68a on the inner peripheral side of protrusion 68. That is, quarter wave plate 52 is disposed on the optical path of light L1 outgoing from optical sheet 30 toward inner end face 68a of protrusion 68. Quarter wave plate 52 is joined onto inner end face 68a using a transparent adhesive. Quarter wave plate 52 covers the whole surface of inner end face 68a, and has an elongated rectangular shape in the horizontal direction although not illustrated. Although not illustrated, quarter wave plate 52 is also disposed on an inner end face of an upper protrusion of display surface 1a, the inner end face of the upper protrusion being opposed to inner end face 68a of protrusion 68 in FIG. 2.

An overall operation of liquid crystal display apparatus 1 having the above configuration will be described below. The light outgoing from light emitting surface 20a of backlight 20 is incident on first functional layer 32 of optical sheet 30. First functional layer 32 transmits the polarized component in the first direction to be transmitted in lower polarizing plate 12, reflects the polarized component in the direction different from the first direction, and repeatedly reflects the polarized component in the direction different from the first direction in backlight 20. Consequently, the polarized direction of the polarized component in the direction different from the first direction is changed to increase a light quantity of the linearly polarized component vibrating in the first direction. As a result, more light from light guide plate 22 can be transmitted through lower polarizing plate 12, and luminance of the light outgoing from display surface 1a of liquid crystal display apparatus 1 can be improved.

The outgoing direction of the light transmitted through first functional layer 32 is controlled by second functional layer 34 of optical sheet 30. For this reason, most of the light outgoing from optical sheet 30 to the front surface side is light traveling within a predetermined angle with respect to normal ‘nd’ of optical sheet 30 in the vertical direction. Consequently, the vertical viewing angle is limited, so that the light toward the windshield of the vehicle can be prevented to prevent the image from being reflected into the windshield. In the first exemplary embodiment, the horizontal viewing angle is not limited.

The light traveling out of the predetermined angle with respect to normal ‘nd’ of optical sheet 30, namely, the light traveling toward the direction largely inclined with respect to normal nd exists slightly in the light outgoing from optical sheet 30.

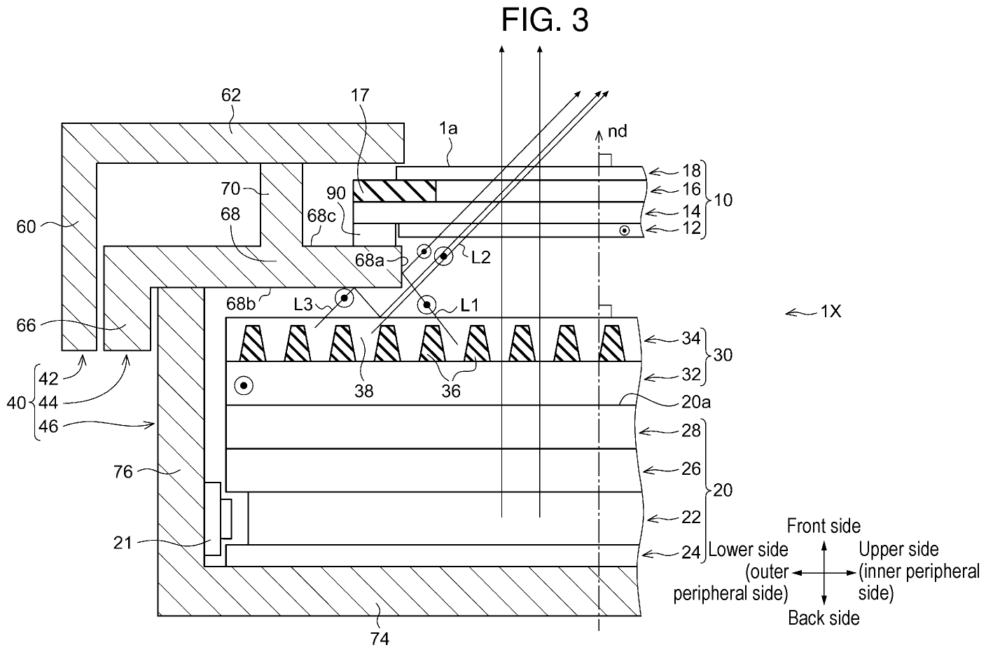

A liquid crystal display apparatus of a comparative example will be described below. FIG. 3 is a sectional view illustrating liquid crystal display apparatus 1X of the comparative example. Liquid crystal display apparatus 1X of the comparative example differs from liquid crystal display apparatus 1 of the first exemplary embodiment in that optical element 50 is not provided.

As illustrated in FIG. 3, there is light L1 outgoing in the direction largely inclined downward with respect to normal ‘nd’ of optical sheet 30 from a region on the inner peripheral side from protrusion 68 in optical sheet 30 toward inner end face 68a of protrusion 68. Light L1 is reflected by inner end face 68a, and directed to the direction largely inclined upward with respect to normal ‘nd’.

There is also light L2 outgoing in the direction largely inclined upward with respect to normal ‘nd’ of optical sheet 30 from a region opposed to protrusion 68 in optical sheet 30 and passing through the vicinity of the edge on the back surface side of inner end face 68a of protrusion 68.

There is light L3 outgoing in the direction largely inclined upward with respect to normal ‘nd’ of optical sheet 30 from the region opposed to protrusion 68 in optical sheet 30 toward back surface 68b of protrusion 68. Light L3 is reflected by back surface 68b of protrusion 68, and then reflected by optical sheet 30. Light L3 reflected by optical sheet 30 passes through the vicinity of the edge on the back surface side of inner end face 68a of protrusion 68, and is directed to the direction largely inclined upward with respect to normal ‘nd’.

Light L1 to light L3 traveling in the direction largely inclined upward with respect to normal ‘nd’ are intensified through each optical path, transmitted through liquid crystal display panel 10, and leak linearly in the horizontal direction from the vicinity of the lower edge of display surface 1a. That is, the light leakage is visually recognized when display surface 1a is viewed from the direction largely inclined upward with respect to normal ‘nd’. As described above, the light leakage is directed to the windshield of the vehicle, and has the possibility of being reflected into the windshield. Similarly, the light that travels in the direction largely inclined downward with respect to normal ‘nd’ and is transmitted through liquid crystal display panel 10 causes the linear light leakage in the horizontal direction from the vicinity of the upper edge of display surface 1a.

On the other hand, in the first exemplary embodiment, as illustrated in FIG. 2, the polarized state of light L1 is changed by optical element 50 because optical element 50 is disposed on the optical path of light L1 outgoing from optical sheet 30 toward protrusion 68. Specifically, light L1 outgoing from optical sheet 30 toward inner end face 68a of protrusion 68 is changed from the linearly polarized light into circularly polarized light by quarter wave plate 52, and reflected by inner end face 68a. Reflected light L1 inverts a rotation direction to maintain the circularly polarized light. Subsequently, reflected light L1 is changed from the circularly polarized light into the linearly polarized light by quarter wave plate 52, and directed to liquid crystal display panel 10. As result, the polarized direction of light L1 incident on liquid crystal display panel 10 is rotated by 90° from the first direction. That is, the polarized direction of light L1 incident on liquid crystal display panel 10 is the second direction. For this reason, light L1 incident on liquid crystal display panel 10 is absorbed by lower polarizing plate 12 of liquid crystal display panel 10, but not transmitted through the front surface side.

Thus, light L1 does not leak, so that the light leakage can be weakened as compared with the comparative example. Consequently, the vehicle can be prevented from being reflected into the windshield. Quarter wave plate 52 is also disposed on the inner end face of the upper protrusion of display surface 1a, the inner end face of the upper protrusion being opposed to inner end face 68a of protrusion 68 in FIG. 2, so that the light leakage can be prevented in the vicinity of the upper edge of display surface 1a.

As described above, in the first exemplary embodiment, optical element 50 that changes the polarized state of light L1 is disposed on the optical path of light L1 outgoing from optical sheet 30 toward inner end face 68a of protrusion 68, so that the light leakage caused by light L1 reflected by inner end face 68a can be prevented.

### Second Exemplary Embodiment

A second exemplary embodiment differs from the first exemplary embodiment in that a half wave plate is provided instead of the quarter wave plate. A difference from the first exemplary embodiment will mainly be described below.

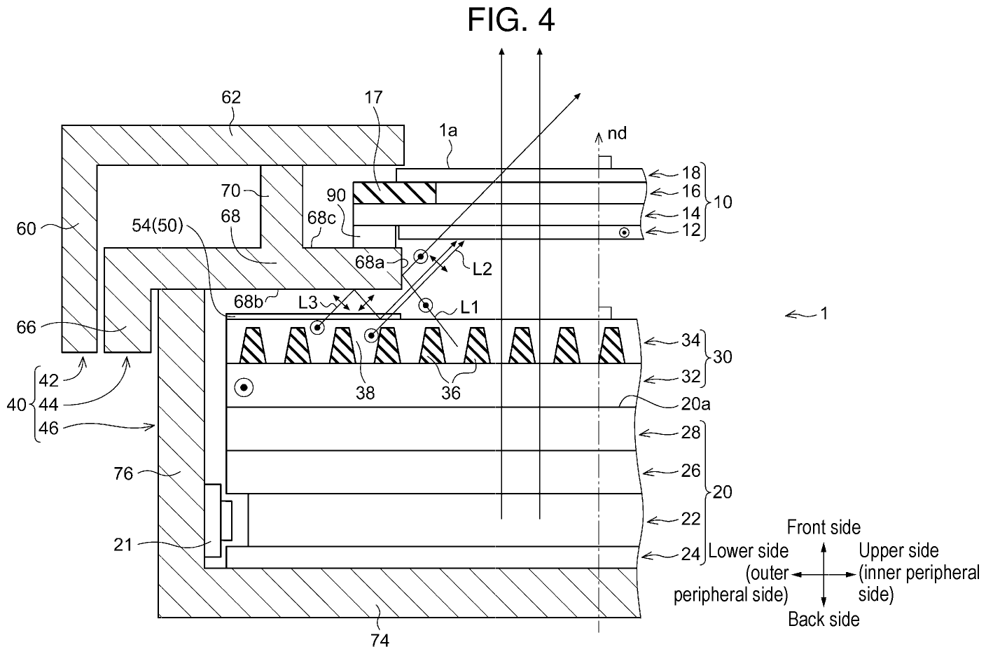

FIG. 4 is a sectional view illustrating liquid crystal display apparatus 1 according to the second exemplary embodiment. Optical element 50 includes half wave plate 54 disposed between optical sheet 30 and protrusion 68. Half wave plate 54 is joined onto the front surface of optical sheet 30 using a transparent adhesive. In planar view, the edge on the inner peripheral side of half wave plate 54 substantially overlaps the edge on the inner peripheral side of protrusion 68, namely, a position of inner end face 68a. The edge on the outer peripheral side of half wave plate 54 is substantially located on the edge on the outer peripheral side of optical sheet 30. That is, half wave plate 54 covers a portion overlapping protrusion 68 in planar view in optical sheet 30. Half wave plate 54 is disposed such that the incident light is transmitted while the polarized direction of the incident light is changed by about 90°. Although not illustrated, half wave plate 54 has an elongated rectangular shape in the horizontal direction.

Because optical element 50 is disposed on the optical path of light L3 outgoing from optical sheet 30 toward back surface 68b of protrusion 68, the polarized state of light L3 is changed by optical element 50, and light L3 is reflected by protrusion 68. Specifically, light L3 is transmitted through half wave plate 54 to change the polarized direction of light L3 outgoing from optical sheet 30 toward back surface 68b of protrusion 68 from the first direction to the second direction. Light L3 transmitted through half wave plate 54 is reflected by back surface 68b of protrusion 68, and transmitted through half wave plate 54 again, and polarized direction of light L3 is changed from the second direction to the first direction. Light L3 is reflected by optical sheet 30, transmitted through half wave plate 54 again to change the polarized direction of light L3 from the first direction to the second direction, and directed to liquid crystal display panel 10. For this reason, light L3 incident on liquid crystal display panel 10 is absorbed by lower polarizing plate 12 of liquid crystal display panel 10, but not transmitted through the front surface side.

Light L2 outgoing in the direction largely inclined upward with respect to normal ‘nd’ of optical sheet 30 from optical sheet 30 and passing through the vicinity of the edge on the back surface side of inner end face 68a of protrusion 68 is also transmitted through half wave plate 54 to change the polarized direction from the first direction to the second direction, and directed to liquid crystal display panel 10. Thus, light L2 is also absorbed by lower polarizing plate 12.

Thus, the light leakage caused by light L3 reflected toward liquid crystal display panel 10 by back surface 68b of protrusion 68 and light L2 directly directed to liquid crystal display panel 10 can be prevented. Consequently, the light leakage can be prevented from being reflected into the windshield of the vehicle.

Half wave plate 54 is joined to the front surface of optical sheet 30, so that light L2 and light L3 can more certainly be transmitted through half wave plate 54 as compared with the case where half wave plate 54 is joined to back surface 68b of protrusion 68.

The edge on the inner peripheral side of half wave plate 54 substantially overlaps the edge on the inner peripheral side of protrusion 68 in planar view, so that the change in polarized direction of the light, which travels within the predetermined angle with respect to normal ‘nd’ of optical sheet 30 and should be transmitted through lower polarizing plate 12, can be prevented.

### Third Exemplary Embodiment

A third exemplary embodiment differs from the first exemplary embodiment in that the inner end face is inclined with no use of the quarter wave plate. A difference from the first exemplary embodiment will mainly be described below.

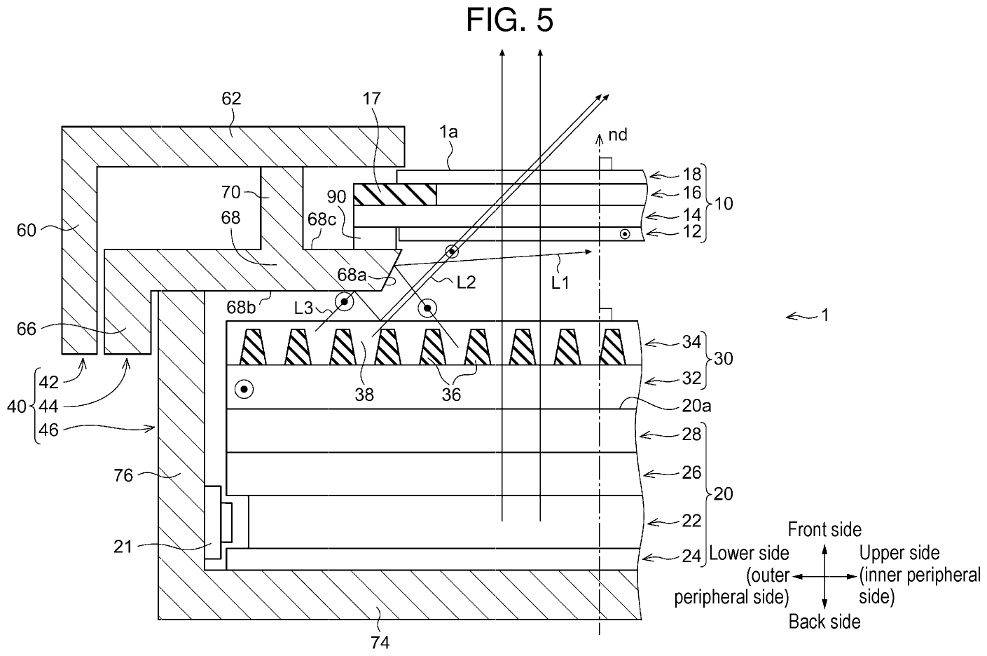

FIG. 5 is a sectional view illustrating liquid crystal display apparatus 1 according to the third exemplary embodiment. Inner end face 68a on the inner peripheral side of protrusion 68 is inclined with respect to normal ‘nd’ of optical sheet 30. That is, inner end face 68a is not parallel to normal ‘nd’. Inner end face 68a is inclined onto the inner peripheral side as it goes from the side of optical sheet 30 toward the side of liquid crystal display panel 10, namely, as it goes from the back surface side toward the front surface side.

In the third exemplary embodiment, because inner end face 68a of protrusion 68 is inclined with respect to normal ‘nd’, the direction of light L1 outgoing from optical sheet 30 and reflected by inner end face 68a of protrusion 68 can be changed to the direction different from the case where inner end face 68a is parallel to normal ‘nd’ as in the comparative example. Specifically, light L1 reflected by inner end face 68a is directed in the direction in which an angle with respect to normal ‘nd’ is larger than that of the comparative example, namely, the direction closer to the direction parallel to display surface 1a. Light L1 hardly exits from display surface 1a to the front surface side. Thus, the light leakage caused by light L1 reflected by inner end face 68a of protrusion 68 can be prevented.

In the third exemplary embodiment, the light leakage can be prevented even if optical sheet 30 does not include first functional layer 32. This is because, unlike the first exemplary embodiment, the light is not absorbed by lower polarizing plate 12 while the polarized state of the light causing the light leakage is changed.

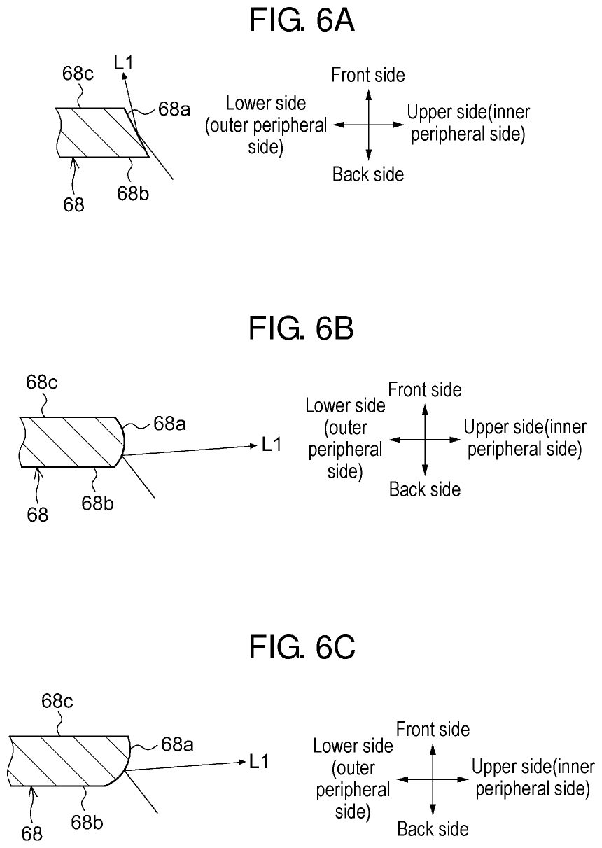

The inclination of inner end face 68a is not limited to the example in FIG. 5, but various inclination can be adopted. An example will be described below. FIGS. 6A to 6C are sectional views illustrating other structures of protrusion 68 in liquid crystal display apparatus 1 of the third exemplary embodiment.

As illustrated in FIG. 6A, inner end face 68a of protrusion 68 may be inclined onto the inner peripheral side as it goes from the side of liquid crystal display panel 10 toward the side of optical sheet 30, namely, as it goes from the front surface side toward the back surface side. In this case, as compared with the case where inner end face 68a is parallel to normal ‘nd’ of optical sheet 30, light L1 reflected by inner end face 68a is directed to the direction in which the angle with respect to normal nd becomes smaller, namely, the direction closer to normal ‘nd’. Light L1 is light traveling within the predetermined angle with respect to normal ‘nd’, but is not intensified with light L2 and light L3. Light L1 can be shielded by black matrix 17. Thus, the light leakage can be prevented.

As illustrated in FIG. 6B, inner end face 68a of protrusion 68 may be a curved surface. Inner end face 68a is not parallel to normal ‘nd’, and is inclined. Even in this case, the effect of the third exemplary embodiment can be obtained. A sharp corner is not provided near inner end face 68a, so that liquid crystal display panel 10 or optical sheet 30 is hardly damaged during assembly of liquid crystal display apparatus 1.

As illustrated in FIG. 6C, inner end face 68a of protrusion 68 is a curved surface, and the edge of front surface 68c may be located on the inner peripheral side from the edge of back surface 68b. Even in this case, the same effect as the example in FIG. 6B can be obtained.

### Fourth Exemplary Embodiment

In a fourth exemplary embodiment, the first exemplary embodiment and the second exemplary embodiment are combined. A difference from the first exemplary embodiment will mainly be described below.

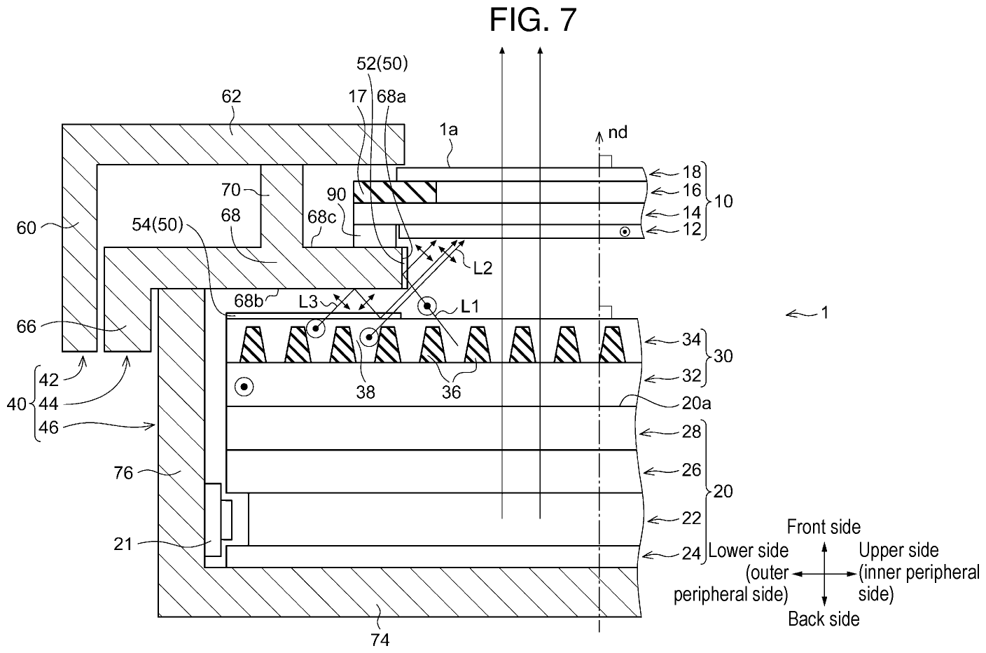

FIG. 7 is a sectional view illustrating liquid crystal display apparatus 1 according to the fourth exemplary embodiment. As illustrated in FIG. 7, optical element 50 includes quarter wave plate 52 disposed on inner end face 68a of protrusion 68 and half wave plate 54 disposed between optical sheet 30 and protrusion 68.

In the third exemplary embodiment, light L1 to light L3 can be absorbed by lower polarizing plate 12. Thus, the light leakage can more certainly be prevented.

### Fifth Exemplary Embodiment

In a fifth exemplary embodiment, the first exemplary embodiment and the third exemplary embodiment are combined. A difference from the first exemplary embodiment will mainly be described below.

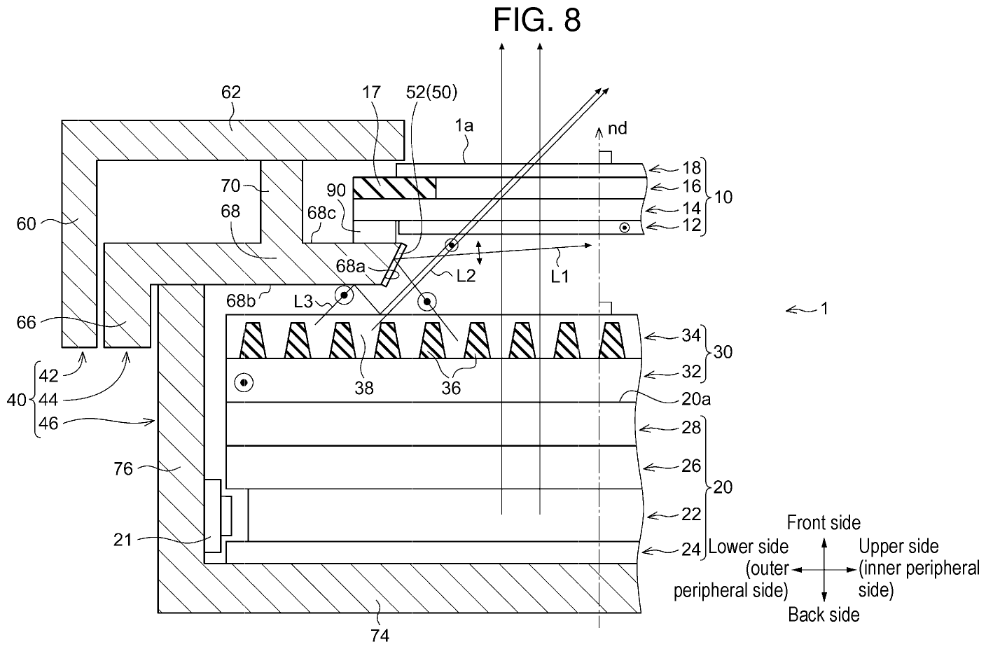

FIG. 8 is a sectional view illustrating liquid crystal display apparatus 1 according to the fifth exemplary embodiment. As illustrated in FIG. 8, inner end face 68a of protrusion 68 is inclined with respect to normal ‘nd’ of optical sheet 30. Optical element 50 includes quarter wave plate 52 disposed on inclined inner end face 68a.

In the fifth exemplary embodiment, the polarized direction of light L1 is changed, and light L1 can be directed to the direction in which the angle with respect to normal ‘nd’ is larger. Consequently, even if the polarized direction of light L1 is insufficiently changed by quarter wave plate 52, the light leakage caused by light L1 can be prevented.

When inner end face 68a is inclined, an area of inner end face 68a can be enlarged as compared with the first exemplary embodiment without increasing a thickness of protrusion 68. Thus, quarter wave plate 52 can more certainly be joined onto inner end face 68a.

The present disclosure is described above according to the exemplary embodiments. It will be understood by those skilled in the art that the exemplary embodiments are merely an example, that other modifications in which constituents and/or processes of the exemplary embodiments are variously combined are possible, and that the other modifications still fall within the scope of the present disclosure.

For example, the second exemplary embodiment and the third exemplary embodiment may be combined to provided half wave plate 54 and inner end face 68a of protrusion 68 inclined with respect to normal ‘nd’ of optical sheet 30. The first, second, and third exemplary embodiments may be combined to provide quarter wave plate 52, half wave plate 54, and inclined inner end face 68a. A new exemplary embodiment generated by the combination has an effect of each of the combined exemplary embodiment.

Second functional layer 34 of optical sheet 30 may limit the horizontal viewing angle in addition to the vertical viewing angle of display surface 1a. In this case, optical element 50 may be provided on the optical path of the light outgoing from optical sheet 30 toward two horizontal protrusions. The inner end face on the inner peripheral side of the two horizontal protrusions may be inclined with respect to normal ‘nd’ of optical sheet 30. In this modification, the light leakage from the vicinities of the right and left edges of display surface 1a can be prevented.

By way of example, liquid crystal display apparatus 1 has the rectangular shape in planar view. Alternatively, for example, liquid crystal display apparatus 1 may have a trapezoidal shape, a semicircular shape, a shape in which four corners are rounded, or a circular shape in planar view. In this case, outer shapes of front frame 42 and middle frame 44 also become the shape of liquid crystal display apparatus 1 in planar view.

Aspects of the present disclosure are as follows.

According to one aspect of the present disclosure, a liquid crystal display apparatus includes a liquid crystal display panel, a light source, an optical sheet, a frame, and an optical element. The light source is opposed to the liquid crystal display panel. The optical sheet is disposed between the liquid crystal display panel and the light source, and includes a first functional layer transmitting a polarized component in one direction of light emitted from the light source and a second functional layer that controls an outgoing direction of the light transmitted through the first functional layer. The frame is disposed around the liquid crystal display panel, and includes a protrusion protruding toward an inner peripheral side between the liquid crystal display panel and the optical sheet and supporting the liquid crystal display panel. The optical element is disposed on an optical path of light outgoing from the optical sheet toward the protrusion of the frame, and changes a polarized state of light.

In this aspect, because the optical element is disposed on the optical path of the light outgoing from the optical sheet toward the protrusion, the polarized state of the light is changed by the optical element, and the light is reflected by the protrusion. Although the light reflected by the protrusion can be directed to the liquid crystal display panel, the light is hardly transmitted through the liquid crystal display panel because the polarized state of the light differs from the polarized state of the light outgoing from the optical sheet. Thus, the light leakage caused by the light reflected by the protrusion can be prevented.

According to one aspect of the present disclosure, the optical element may include a half wave plate disposed between the optical sheet and the protrusion.

In this case, the light outgoing from the optical sheet toward the back surface of the protrusion is reflected by the back surface of the protrusion and the optical sheet, the polarized direction is changed by the half wave plate, and the light is directed to the liquid crystal display panel. The light in which the polarized direction is changed is hardly transmitted through the liquid crystal display panel. Thus, the light leakage caused by the light reflected by the back surface of the protrusion can be prevented.

According to one aspect of the present disclosure, the half wave plate may be joined to the optical sheet.

In this case, as compared with the case where the half wave plate is joined to the back surface of the protrusion, the light passing through the vicinity of the edge on the back surface side of the inner end face of the protrusion can more certainly be transmitted through the half wave plate. Thus, the light can be absorbed by the lower polarizing plate, and the light leakage can further be prevented.

According to one aspect of the present disclosure, the optical element may include a quarter wave plate disposed on an inner end face of the protrusion.

In this case, the light outgoing from the optical sheet toward the inner end face of the protrusion is reflected by the inner end face, the polarized direction is changed by the quarter wave plate, and the light is directed to the liquid crystal display panel. The light in which the polarized direction is changed is hardly transmitted through the liquid crystal display panel. Thus, the light leakage caused by the light reflected by the inner end face of the protrusion can be prevented.

According to one aspect of the present disclosure, an inner end face on an inner peripheral side of the protrusion may be inclined with respect to a normal of the optical sheet.

In this case, the direction of the light outgoing from the optical sheet and is reflected by the inner end face of the protrusion can be changed to the direction different from the case where the inner end face is parallel to the normal of the optical sheet. Thus, the light leakage can further be prevented.

According to one aspect of the present disclosure, the inner end face on the inner peripheral side of the protrusion may be inclined with respect to a normal of the optical sheet.

In this case, the direction of the light outgoing from the optical sheet and is reflected by the inner end face of the protrusion can be changed to the direction different from the case where the inner end face is parallel to the normal of the optical sheet. Thus, the light leakage can further be prevented.

According to one aspect of the present disclosure, a liquid crystal display apparatus includes a liquid crystal display panel, a light source, an optical sheet, and a frame. The light source is opposed to the liquid crystal display panel. The optical sheet is disposed between the liquid crystal display panel and the light source, and controls an outgoing direction of light emitted from the light source. The frame is disposed around the liquid crystal display panel, and includes a protrusion protruding toward an inner peripheral side between the liquid crystal display panel and the optical sheet and supporting the liquid crystal display panel. An inner end face on an inner peripheral side of the protrusion is inclined with respect to a normal of the optical sheet.

In this aspect, the direction of the light outgoing from the optical sheet and is reflected by the inner end face of the protrusion can be changed to the direction different from the case where the inner end face is parallel to the normal of the optical sheet. Thus, the light leakage caused by the light reflected by the inner end face of the protrusion can be prevented.

According to one aspect of the present disclosure, the inner end face of the protrusion may be inclined onto an inner peripheral side from an optical sheet side toward a liquid crystal display panel side.

In this case, as compared with the case where the inner end face is parallel to the normal of the optical sheet, the light reflected by the inner end face is directed to the direction in which the angle with respect to the normal becomes smaller. Thus, the light leakage caused by the light reflected by the inner end face of the protrusion can be prevented.

### INDUSTRIAL APPLICABILITY

The present disclosure relates to the liquid crystal display apparatus having the viewing angle limiting function, particularly to the liquid crystal display apparatus and the like that can prevent the light leakage.

### REFERENCE MARKS IN THE DRAWINGS

1 liquid crystal display apparatus
1a display surface
1X liquid crystal display apparatus of comparative example
10 liquid crystal display panel
12 lower polarizing plate
14 thin film transistor substrate
16 color filter substrate
17 black matrix
18 upper polarizing plate
20 backlight
20a light emitting surface
21 light emitting source
22 light guide plate
24 reflector
26 diffuser
28 prism sheet
30 optical sheet
32 first functional layer
34 second functional layer
36 light shielding unit
38 light transmission layer
40 support frame
42 front frame
44 middle frame
46 rear frame
50 optical element
52 quarter wave plate
54 half wave plate
60 sidewall
62 bezel
66 sidewall
68 protrusion
68a inner end face
68b back surface
68c front surface
70 sidewall
74 back surface unit
76 sidewall
90 cushion tape
L1 light
L2 light
L3 light
nd normal

1. A liquid crystal display apparatus comprising:
a liquid crystal display panel including a display surface and a rear surface on an opposite side to the display surface;
a light source opposed to the rear surface of the liquid crystal display panel;
an optical sheet disposed between the liquid crystal display panel and the light source, the optical sheet including a first functional layer opposed to the light source and a second functional layer opposed to the rear surface of the liquid crystal display panel;
a frame including (i) a sidewall disposed around the rear surface of the liquid crystal display panel and (ii) a protrusion protruding from the sidewall between the liquid crystal display panel and the optical sheet; and
an optical element disposed on an optical path of light outgoing from the optical sheet toward the protrusion of the frame, wherein
the first functional layer transmits a polarized component in one direction of light emitted from the light source, the second functional layer controls an outgoing direction of the light transmitted through the first functional layer,
the protrusion extends between the liquid crystal display panel and the optical sheet in an inner peripheral direction of the frame from the sidewall of the frame toward the liquid crystal display panel, and supports the liquid crystal display panel, and
the optical element changes a polarized state of light directed to the protrusion.

2. The liquid crystal display apparatus according to claim 1, wherein the optical element includes a half wave plate disposed between the optical sheet and the protrusion.

3. The liquid crystal display apparatus according to claim 2, wherein the half wave plate is joined to the optical sheet.

4. The liquid crystal display apparatus according to claim 1, wherein the optical element includes a quarter wave plate disposed on an inner end face located at an end of the protrusion in the inner peripheral direction.

5. The liquid crystal display apparatus according to claim 2, wherein the optical element includes a quarter wave plate disposed on an inner end face located at an end of the protrusion in the inner peripheral direction.

6. The liquid crystal display apparatus according to claim 3, wherein the optical element includes a quarter wave plate disposed on an inner end face located at an end of the protrusion in the inner peripheral direction.

7. The liquid crystal display apparatus according to claim 4, wherein the inner end face is inclined with respect to a normal of the optical sheet.

8. The liquid crystal display apparatus according to claim 5, wherein the inner end face is inclined with respect to a normal of the optical sheet.

9. The liquid crystal display apparatus according to claim 6, wherein the inner end face is inclined with respect to a normal of the optical sheet.

10. The liquid crystal display apparatus according to claim 1, wherein an inner end face located at an end of the protrusion in the inner peripheral direction is inclined with respect to a normal of the optical sheet.

11. The liquid crystal display apparatus according to claim 2, wherein an inner end face located at an end of the protrusion in the inner peripheral direction is inclined with respect to a normal of the optical sheet.

12. The liquid crystal display apparatus according to claim 3, wherein an inner end face located at an end of the protrusion in the inner peripheral direction is inclined with respect to a normal of the optical sheet.

13. The liquid crystal display apparatus according to claim 1, wherein
the liquid crystal display panel includes a polarizing plate on the rear surface, and
the polarizing plate is installed to transmit the light transmitted through the first functional layer.

14. The liquid crystal display apparatus according to claim 2, wherein
the liquid crystal display panel includes a polarizing plate on the rear surface, and
the polarizing plate is installed to transmit the light transmitted through the first functional layer.

15. The liquid crystal display apparatus according to claim 3, wherein
the liquid crystal display panel includes a polarizing plate on the rear surface, and
the polarizing plate is installed to transmit the light transmitted through the first functional layer.

16. The liquid crystal display apparatus according to claim 4, wherein
the liquid crystal display panel includes a polarizing plate on the rear surface, and
the polarizing plate is installed to transmit the light transmitted through the first functional layer.

17. The liquid crystal display apparatus according to claim 5, wherein
the liquid crystal display panel includes a polarizing plate on the rear surface, and
the polarizing plate is installed to transmit the light transmitted through the first functional layer.

18. The liquid crystal display apparatus according to claim 6, wherein
the liquid crystal display panel includes a polarizing plate on the rear surface, and
the polarizing plate is installed to transmit the light transmitted through the first functional layer.

19. A liquid crystal display apparatus comprising:
a liquid crystal display panel including a display surface and a rear surface on an opposite side to the display surface;
a light source opposed to the rear surface of the liquid crystal display panel;
an optical sheet disposed between the liquid crystal display panel and the light source and opposed to the light source, the optical sheet controlling an outgoing direction of light emitted from the light source; and
a frame including a sidewall disposed around the rear surface of the liquid crystal display panel and a protrusion protruding from the sidewall between the liquid crystal display panel and the optical sheet, and
wherein the protrusion extends between the liquid crystal display panel and the optical sheet in an inner peripheral direction from the sidewall of the frame toward the liquid crystal display panel, and supports the liquid crystal display panel, and an inner end face located at an end of the protrusion in the inner peripheral direction is inclined with respect to a normal of the optical sheet.

20. The liquid crystal display apparatus according to claim 19, wherein the inner end face is inclined in the inner peripheral direction from the optical sheet toward the liquid crystal display panel.
